(19) United States
(12) Patent Application Publication
(10) Pub. No.: US 2006/0032686 A1
(43) Pub. Date: Feb. 16, 2006

(54) Spindle for snowmobile suspension

(76) Inventor: Norman Berg, Roseau, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/916,949

(22) Filed: Aug. 12, 2004

(51) Int. Cl. B62M 27/00; B62M 27/02

(52) U.S. Cl. 180/190; 280/21.1; 280/124.135

(57) ABSTRACT

A suspension support spindle for a recreational vehicle that is lightweight, strong, and that improves aerodynamic performance by reducing friction and drag. An extruded spindle design for use in a front suspension system of a snowmobile, using aluminum as the extrusion material and performing the extrusion along an axis that is generally parallel to a forward direction of travel of the snowmobile. A method of manufacturing an extruded snowmobile suspension spindle.

### FIELD OF THE INVENTION

The invention relates to suspension systems for recreational vehicles such as snowmobiles, all terrain vehicles (ATVs), and other similar vehicles. More particularly, the invention relates to the construction of a front suspension support for use on such vehicles.

### BACKGROUND

Snowmobiles are popular land vehicles used as transportation vehicles or as recreational vehicles in cold and snowy conditions. In general, a snowmobile has a central frame or chassis on or around which the various components of the snowmobile are assembled. Typical snowmobiles include skis for steering, a seat, handlebars, and an endless track for propulsion mounted to a central chassis. An engine cradle or bulkhead is defined by a plurality of front structural members of the chassis. The engine drives a ground-engaging endless track disposed in a longitudinally extending drive tunnel formed within the chassis. The skis serve to facilitate steering as well as to provide flotation of the front of the snowmobile over the snow in which it is operated. The skis are mounted at the front body portion of the chassis. A handlebar assembly, positioned forward of the seat, is operatively linked to the skis for steering the snowmobile. The skis may be pivoted laterally to steer the snowmobile, for example, by turning the handlebars.

The skis support the front of the snowmobile using a suspension system that may include suspension arms mounted to the snowmobile chassis that attach to and support a spindle. Suspension arms may be of the “trailing arm” variety, employing an elongated structural member attached at its front end to a spindle, and pivotally attached at its rear end to the chassis of the snowmobile. Suspension arms may also be of the “A-arm” variety, typically employing two A-shaped control arms that are pivotally mounted to the snowmobile chassis and that connect to a spindle.

Each spindle may be attached to a ski to form the operative link in the steering system whereby movement of the handlebars causes rotation of the spindles, which causes the skis to turn. As a consequence of the suspension and steering functions it must perform, snowmobile ski spindles experience high stresses during use. Spindles are desired which possess high strength in bending and torsion and which can withstand the high stresses imposed by snowmobile use, without increasing the weight of the vehicle to such an extent that performance is negatively affected. Spindles are also desired which improve the performance of a snowmobile by providing a streamlined, aerodynamic profile.

### BRIEF SUMMARY OF THE INVENTION

An improved snowmobile suspension system is provided that incorporates a novel spindle design. In one embodiment, a snowmobile ski spindle is disclosed that is very strong, yet relatively lightweight. An embodiment of the invention disclosed provides a snowmobile ski spindle that is adapted to be moveably connected to suspension arms along the innermost side of the spindle. The snowmobile ski spindle may also be connected to a mechanical link that enables steering of the snowmobile skis upon rotation of the spindle about an axis that extends between the points at which the suspension arms are moveably connected to the spindle.

One embodiment of the invention provides a snowmobile ski spindle adapted to be formed by an extrusion process that includes extruding a material in a direction generally parallel to a direction of forward travel of the snowmobile. The snowmobile ski spindle can be designed to allow air to pass through it in the direction of vehicle travel, thereby reducing drag and improving aerodynamic performance.

Also provided is a method of forming a snowmobile ski spindle using an extrusion process that includes extruding a material in a direction generally parallel to a direction of forward travel of the snowmobile.

### BRIEF DESCRIPTION OF THE DRAWINGS

FIG. 1 is a side view of a snowmobile.

FIG. 2 is a cut-away perspective view of a snowmobile chassis and suspension system according to an embodiment of the invention.

FIG. 3 is a front, right perspective view of a snowmobile front suspension system according to an embodiment of the invention.

FIG. 4 is a front, top, left perspective view of a snowmobile front suspension system according to an embodiment of the invention.

FIG. 5 is a left side view of a snowmobile front suspension system according to an embodiment of the invention.

FIG. 6 is a front view of a snowmobile front suspension system according to an embodiment of the invention.

FIG. 7 is a front, top, left perspective view of a left snowmobile ski spindle according to an embodiment of the invention.

FIG. 8 is a front, top, right perspective view of a left snowmobile ski spindle according to an embodiment of the invention.

FIG. 9 is a front view of a left snowmobile ski spindle according to an embodiment of the invention.

FIG. 10 is a right side view of a left snowmobile ski spindle according to an embodiment of the invention.

FIG. 11 is a left side view of a left snowmobile ski spindle according to an embodiment of the invention.

FIG. 12 is a block diagram of an extrusion process for forming a snowmobile ski spindle according to an embodiment of the invention.

FIG. 13 is a front view of a snowmobile ski spindle with a cover according to an embodiment of the invention.

FIG. 14 is a side view of a snowmobile with a trailing arm suspension system.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described above are merely for illustrative purposes, and are not intended to limit the scope of the invention as defined in the claims that follow.

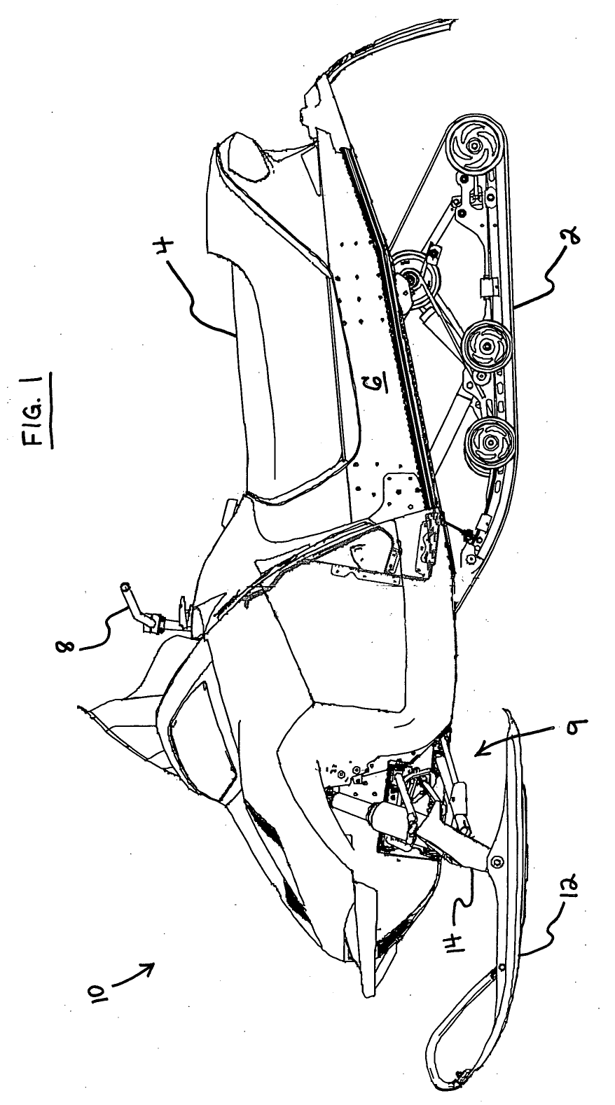

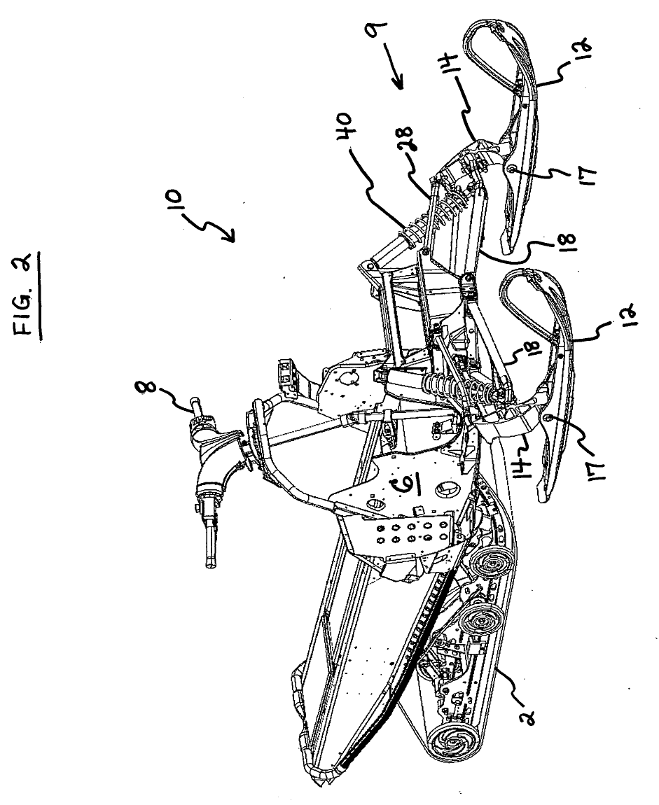

Referring to FIGS. 1 and 2, a snowmobile 10 is depicted as having an endless track unit 2, a seat 4, a chassis 6, a handlebar 8, a pair of steerable front skis 12, and a front suspension system 9 for the attachment and support of the snowmobile chassis 6 relative to the skis 12.

There are 2 basic types of front suspension systems used in snowmobiles: double A-arm (or A-frame) type suspensions and trailing arm suspensions. The descriptions that follow depict the embodiments of the invention as it would be used with a double A-arm type suspension system. However, the descriptions are exemplary, and a person of ordinary skill in the art would readily appreciate the applicability and use of the embodiments of the invention in a trailing arm type suspension system. Only one side of the front suspension system 9 will be described, it being understood that the other side is a mirror image of the side being discussed.

Front suspension system 9 can include a linkage arrangement including an upper A-frame suspension linkage 28 and a lower A-frame suspension linkage 18. Upper and lower A-frame suspension linkages 28, 18 may interconnect chassis 6 of snowmobile 10 to spindle 14. Spindle 14 may have ski 12 pivotably attached to the lower end thereof by a pivot pin 17.

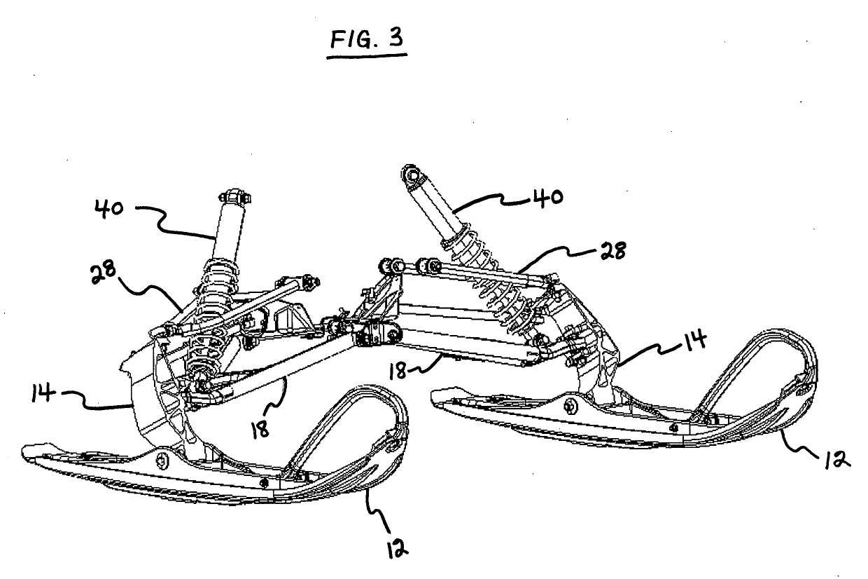

Referring to FIGS. 3-6, upper A-frame suspension linkage 28 has forward and rearward ends 30, 32 that may each be pivotably attached to chassis 6, for example via bushings, in a manner that allows upper A-frame suspension linkage 28 to pivot about an axis 34. Similarly, lower A-frame suspension linkage 18 has forward and rearward ends 20, 22 that may each be pivotably attached to chassis 6, for example via bushings, in a manner that allows lower A-frame suspension linkage 18 to pivot about an axis 26. The apex 36 of the upper A-frame suspension linkage 28 can be moveably attached to spindle 14 at 35, for example by use of a ball joint. Similarly, the apex 24 of the lower A-frame suspension linkage 18 can be moveably attached to spindle 14 at 15, for example by use of a ball joint.

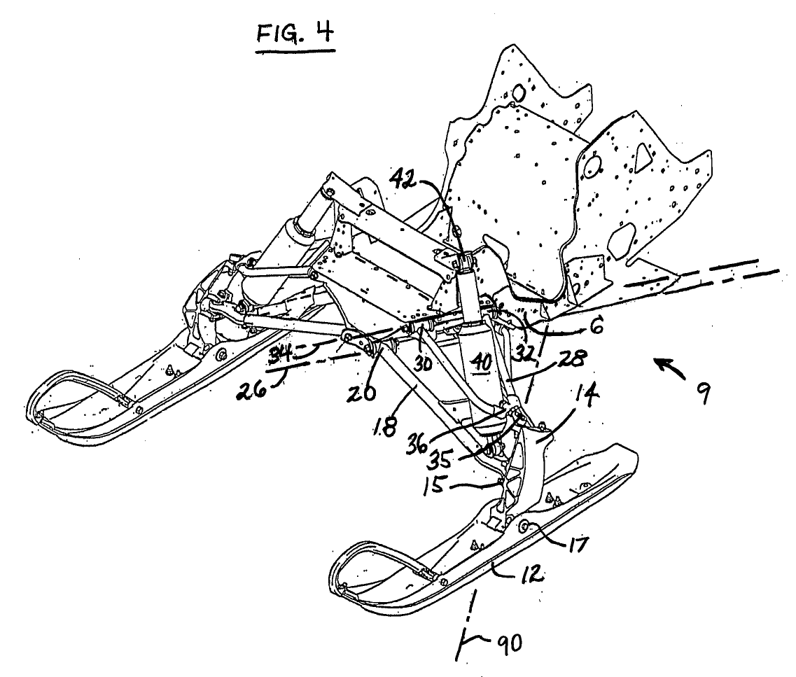

With reference to FIG. 4, shock absorber 40 can be connected at its lower end with lower A-frame suspension linkage 18. Shock absorber 40 may, for example, be connected at its lower end with lower A-frame suspension linkage 18 near apex 24. Shock absorber 40 may be pivotally attached at its upper end 42 to the chassis 6, as is shown in one possible embodiment in FIG. 4. Shock absorber 40 can dampen forces applied to ski 12 and movement of ski 12 relative to the chassis 6, and can transfer weight from the snowmobile 10 to the skis 12 as snowmobile 10 travels over uneven terrain. Both upper and lower A-frame suspension linkages 28, 18 are moveably connected to spindle 14 and permit spindle 14 to move generally vertically relative to chassis 6 as snowmobile 10 travels over uneven terrain.

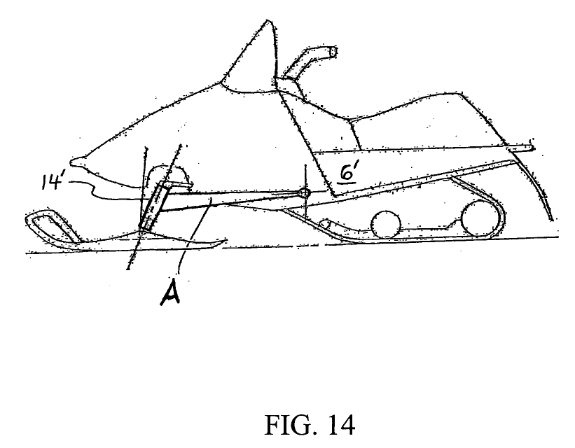

The trailing arm type suspension system mentioned above (shown generally in FIG. 14) differs from the double A-arm type suspension in that, instead of having a pair of A-frame linkages that extend outwardly from the chassis 6 and connect the chassis 6 to the spindle 14, a trailing arm (labeled “A” in FIG. 14) is coupled at one end to a spindle 14′ and extends rearwardly from the spindle 14′, moveably coupled to the chassis 6′ a distance longitudinally behind the spindle 14′. Either the trailing arm type or the double A-arm type of suspension can be used with embodiments of the invention, as would be readily appreciated by a person of ordinary skill in the art.

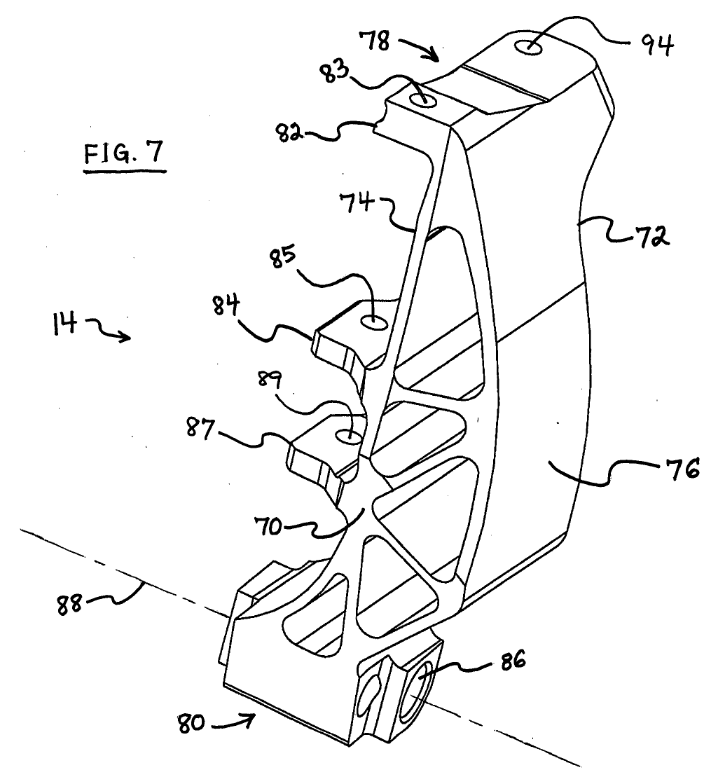

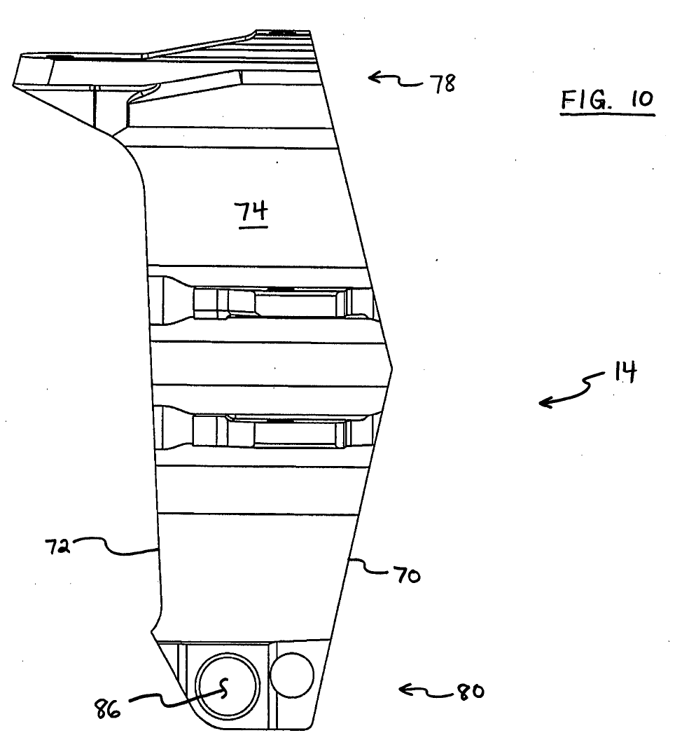

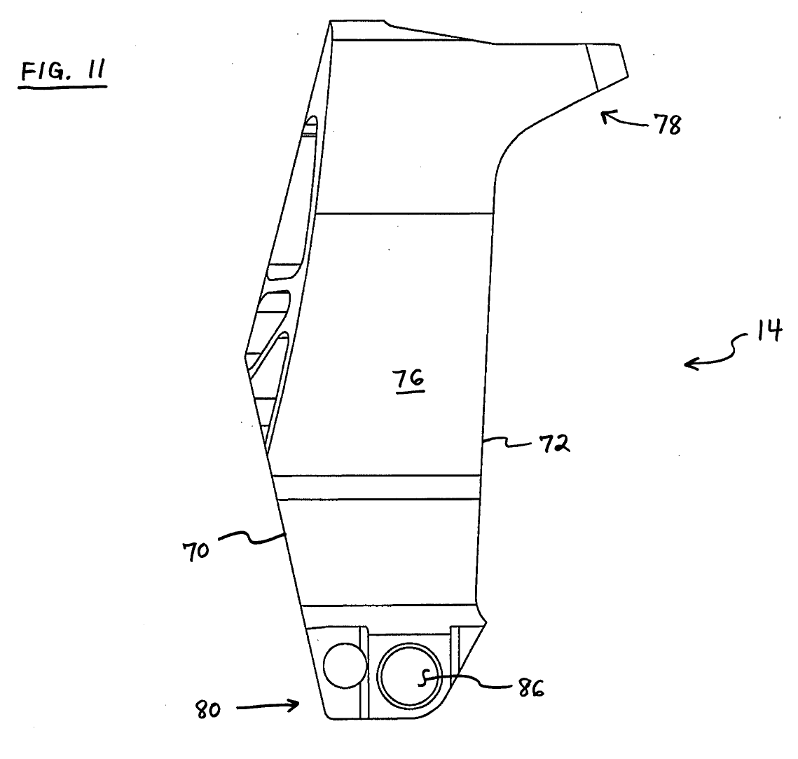

FIGS. 7-11 illustrate several views of a possible embodiment of spindle 14. Only one spindle will be described in detail, it being understood that the other spindle is a mirror image of the one being described.

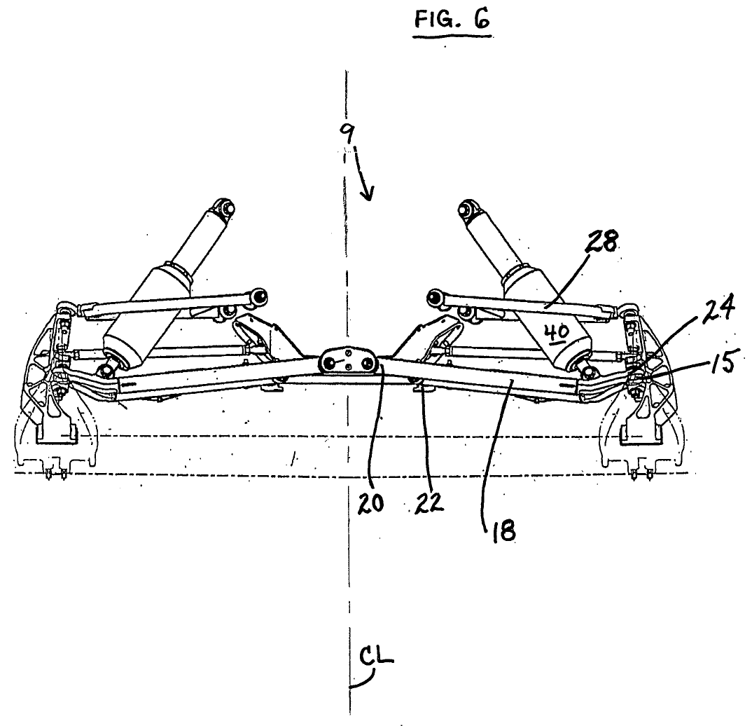

Spindle 14 can be an elongate structure which may include an upper portion 78, lower portion 80, front side 70, rear side 72, inner side 74, and an outer side 76. Ski 12 may be pivotally attached to spindle 14 at its lower portion 80, for example through use of pivot pin 17 extending through pivot hole 86. This pivotal connection allows ski 12 to pivot about axis 88. However, any pivotal connection may be employed so long as ski 12 is permitted to pivot about an axis 88. The front and rear sides 70, 72 of spindle 14 are defined with respect to the normal, forward direction of travel of snowmobile 10. The inner and outer sides 74, 76 of spindle 14 are defined with respect to the relative proximity of each to the centerline (indicated as CL in FIG. 6) of snowmobile 10.

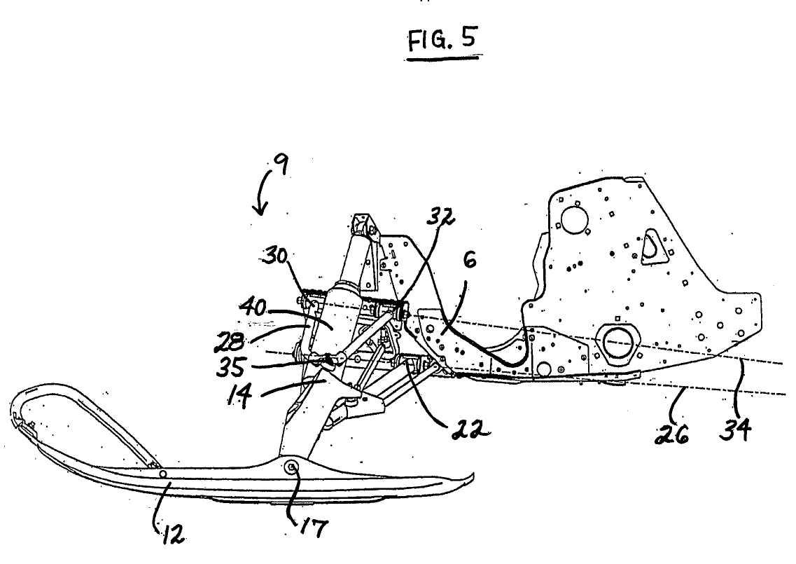

In an embodiment of the invention, spindle 14 may include first and second protrusions 82, 84 that project inwardly (toward CL in FIG. 6) from the inner side 74 of spindle 14. First protrusion 82 may be disposed generally above second protrusion 84. First and second protrusions 82, 84 may include suspension connection openings 83, 85 respectively, positioned therein. Upper A-frame suspension linkage 28 may be moveably connected to spindle 14 at 35 (see FIGS. 4 and 5) using opening 83 in first protrusion 82, for example by using a ball joint. Similarly, lower A-frame suspension linkage 18 may be moveably connected to spindle 14 at 15 (see FIGS. 4 and 6) using opening 85 in second protrusion 84, for example by using a ball joint. The ball joints used at 15 and 35 may be any suitable ball joint known by a person having ordinary skill in the art. Alternatively, other moveable means of connection may be employed to connect spindle 14 to upper and lower A-frame suspension linkages 28, 18.

In one possible embodiment of the invention, spindle 14 may include a third protrusion 87 that projects inwardly from the inner side 74 of spindle 14. The third protrusion 87 may include suspension connection opening 89 and may provide additional support for the rotational connection of lower A-frame suspension linkage 18 to spindle 14 at 15.

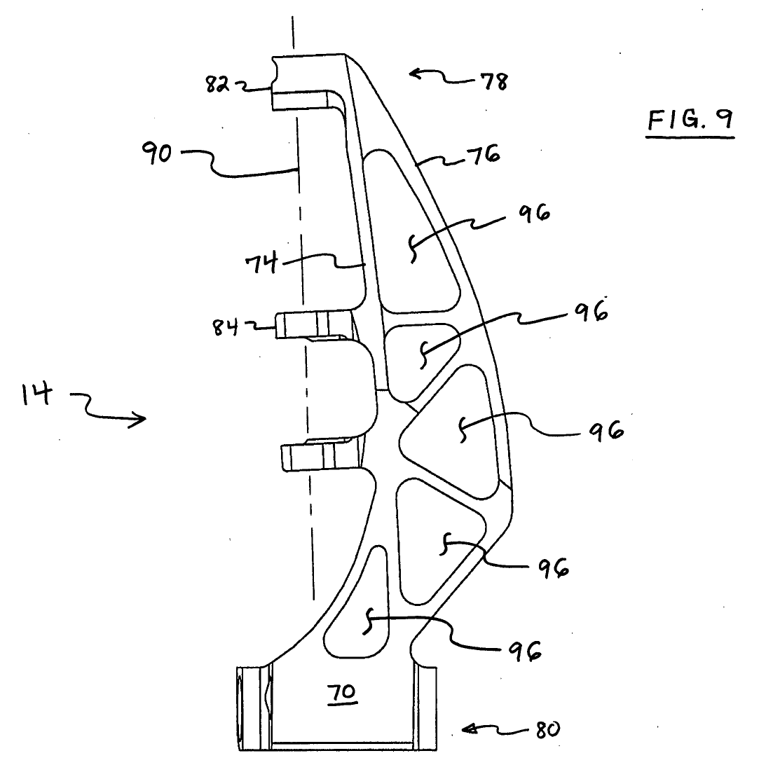

FIG. 9 is a front view of spindle 14. The relative positioning of openings 83, 85 in protrusions 82, 84 form an axis of rotation 90 about which spindle 14 may rotate to turn ski 12 when acted upon by mechanical steering linkages (not shown).

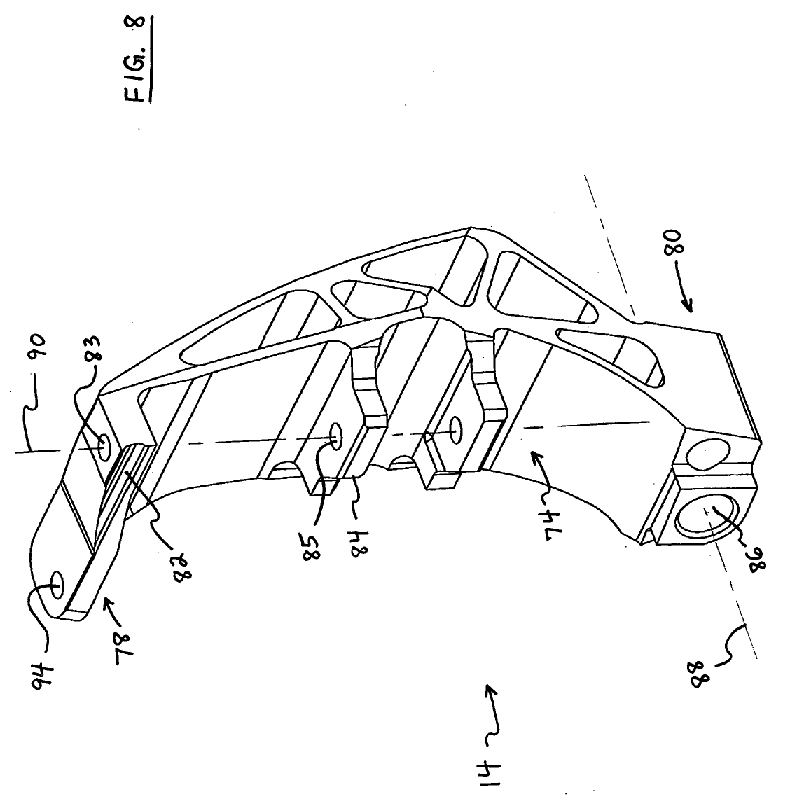

To steer snowmobile 10, handlebar 8 (see FIGS. 1 and 2) may be rotated, causing a mechanical linkage (not shown) to exert force on spindle 14, causing spindle 14 to rotate about axis of rotation 90. The point at which force is exerted upon spindle 14 by mechanical steering linkage may be any suitable location that causes the desired rotation of spindle 14. FIGS. 7 and 8 show one possible location, indicated by steering connection opening 94 near the rear part of upper portion 78 of spindle 14. The steering linkage may be moveably connected at opening 94 using a ball joint (not shown), which may be similar to the ball joints used in connecting first and second protrusions 82, 84 to the upper and lower A-frame suspension linkages 28, 18 at 35, 15. As spindle 14 rotates, ski 12 attached to lower portion 80 of spindle 14 turns, providing steering capability for snowmobile 10. Axis of rotation 90 may be oriented generally vertically, although a particular embodiment may have an axis of rotation 90 that varies as much as 45 degrees or more from vertical.

In an embodiment of the invention, spindle 14 may be formed as an extruded material. Any material that possesses certain desired characteristics, such as weight and strength, may be used. In an embodiment, the extrusion may be performed along an axis of extrusion that is generally parallel to the direction of forward travel of the vehicle. In another possible embodiment, spindle 14 may be constructed of aluminum, which provides strength while minimizing weight. Aluminum is considered a suitable material due to its strength and weight characteristics, as well as for its resistance to rust and corrosion. However, as would be understood by a person having ordinary skill in the art, spindle 14 may be constructed from any suitable material or made according to a different manufacturing process.

As illustrated in FIGS. 7-9, spindle 14 may have an open web construction pattern. The open web construction pattern may be the result of forming spindle 14 in an extrusion process. Spindle 14 may include extrusion holes 96 spaced throughout, as shown in FIG. 9. The extrusion holes 96 provide desirable aspects of spindle 14, such as reducing the overall weight and assisting in producing the desired shape. Further, the extrusion holes 96 may be oriented along an axis of extrusion that is generally parallel to a direction of forward travel of the vehicle. This extrusion axis orientation allows air to pass through the extrusion holes 96 during motion of the vehicle, which may reduce air resistance and drag and thereby improve vehicle performance.

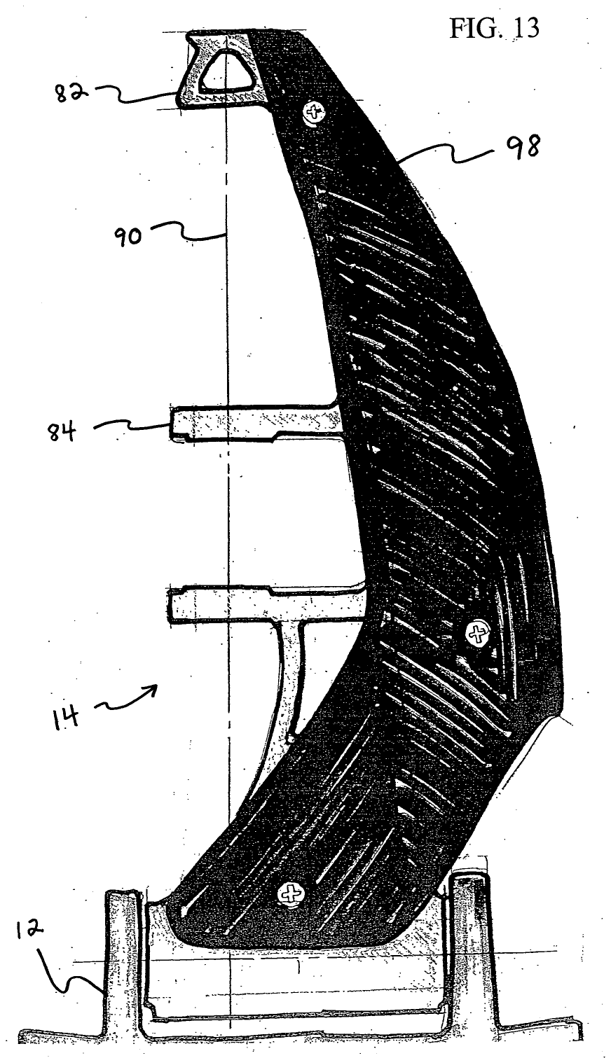

FIG. 13 illustrates an embodiment of the invention in which spindle 14 may be adapted to receive a cover 98 positioned on either or both of the front and rear sides 70, 72 of spindle 14. A cover 98 may be desirable in certain weather conditions, for example, to keep wet snow and ice from building up inside extrusion holes 96. Alternately, a cover 98 may be added or removed to adjust or modify the aerodynamic profile of spindle 14 to affect performance. The cover 98 may be made of plastic or other suitable material, and may be held in place using any suitable method, examples of which might include adhesives, press fittings, and/or fasteners placed through the cover and inserted into openings (not shown) in spindle 14.

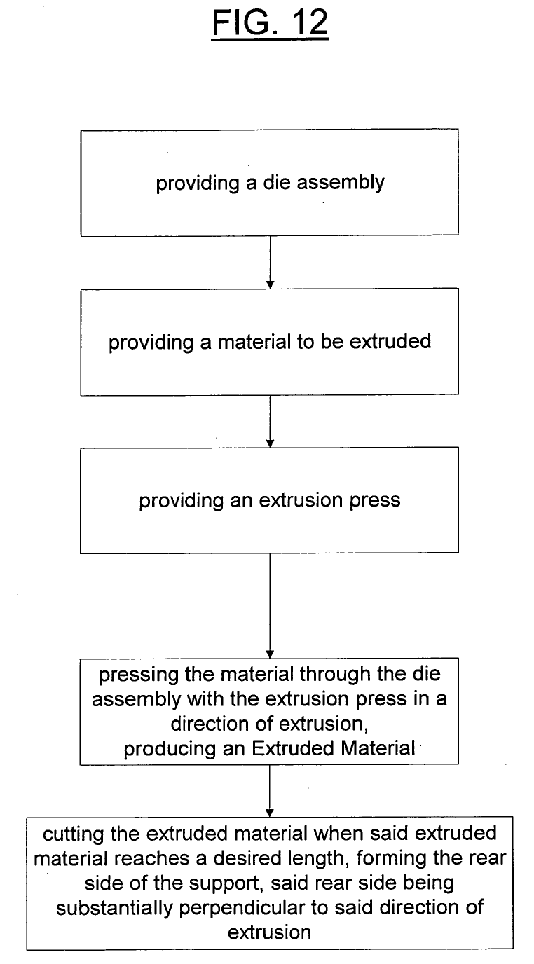

The process of manufacturing spindle 14 may be an extrusion process. FIG. 12 describes the basic steps in forming spindle 14 via an extrusion process. The steps include: providing a die assembly for forming the desired shape and pattern characteristics of the extrusion; providing a material to be extruded, such as a metal or other suitable material; providing an extrusion press for forcing the extrusion material through the die assembly; pressing the material through the die assembly with the extrusion press in a direction of extrusion, producing an extruded material; and cutting the extruded material when said extruded material reaches a desired length. The surface created by cutting the extruded material may form either the front side 70 or the rear side 72 of the spindle 14, the surface being generally perpendicular to said direction of extrusion. In one embodiment, aluminum is used as the material to be extruded, although any material possessing the desired strength and weight characteristics could be used.

As would be appreciated by a person of ordinary skill in the art, spindle 14 could be applied to the design of a front suspension for other recreational vehicles, such as wheeled vehicles, without departing from scope of the present invention.

Accordingly it should be readily apparent that a recreational vehicle incorporating the concepts of the embodiments of an improved suspension spindle will achieve improved performance due to the strength and weight characteristics of the improved spindle, as well as its improved aerodynamic profile. It should be understood that other forms of the improved spindle are contemplated by the embodiments of the invention and that numerous modifications may be made by those of skill in the art without departing from the scope of the invention.

What is claimed is:

1. A support for a recreational vehicle, the support comprising:
a body having
a front side, a rear side, an inner side, a lower portion adapted to be moveably coupled to a ground engaging element of the recreational vehicle,
a first protrusion projecting from the inner side of the body, and
a second protrusion projecting from the inner side of the body, wherein the first protrusion is disposed generally above the second protrusion, the first and second protrusions being adapted to be moveably coupled to a portion of a suspension system of the recreational vehicle.

2. The support of claim 1 wherein at least one of the first and second protrusions is adapted to be moveably coupled to an A-frame suspension element of the recreational vehicle.

3. The support of claim 2 further comprising a third protrusion projecting from the inner side of the body, the third protrusion being adapted to be moveably coupled to an A-frame suspension element.

4. The support of claim 2 wherein the body is adapted to be moveably coupled to a portion of a steering system of the recreational vehicle.

5. The support of claim 4 wherein the body is adapted to rotate about an axis of rotation upon actuation of the steering system, wherein the axis of rotation is defined by a line which passes through the first and second protrusions.

6. The support of claim 1 wherein the recreational vehicle is a snowmobile.

7. A support for a recreational vehicle, the support comprising:
an elongated body having
a front side defined by a forward direction of travel of the recreational vehicle,
a rear side defined by a rearward direction of travel of the recreational vehicle,
an inner side proximate a longitudinal centerline of the recreational vehicle,
a lower portion adapted to be moveably coupled to a ground engaging element of the recreational vehicle,
first and second protrusions projecting from the inner side of the body, the first protrusion being disposed generally above the second protrusion, the first and second protrusions being adapted to be moveably coupled to a portion of a suspension system of the recreational vehicle.

8. The support of claim 7 wherein the elongated body further comprises:
an outer side distal the longitudinal centerline of the recreational vehicle, and
an upper portion adapted to be moveably coupled to a portion of a steering system of the recreational vehicle.

9. A support for a recreational vehicle, the support comprising:
an elongated body having
a front side defined by a forward direction of travel of the recreational vehicle,
a rear side defined by a rearward direction of travel of the recreational vehicle,
an inner side proximate a longitudinal centerline of the recreational vehicle,
an outer side distal a longitudinal centerline of the recreational vehicle,
an upper portion adapted to be moveably coupled to a portion of a steering system of the recreational vehicle,
a lower portion adapted to be moveably coupled to a ground engaging element of the recreational vehicle,
first and second protrusions projecting from the inner side of the body, the first protrusion being disposed generally above the second protrusion, the first and second protrusions being adapted to be moveably coupled to a portion of a suspension system of the recreational vehicle;
wherein the body has an axis of rotation defined by a line which passes through the first and second protrusions and wherein the body is adapted to rotate about the axis of rotation upon actuation of the steering system.

10. The support of claim 9 wherein the first and second protrusions are adapted to be moveably coupled to at least one A-frame suspension element of the recreational vehicle.

11. The support of claim 10 wherein the elongated body is formed from an extruded material.

12. The support of claim 11 wherein the extruded material is aluminum.

13. The support of claim 11 wherein the extruded material has a direction of extrusion that is generally parallel to the forward direction of travel of the recreational vehicle.

14. The support of claim 11 wherein at least one of the front and rear sides of the body are adapted to mountably receive a cover.

15. A spindle for a snowmobile, the spindle comprising:
an elongated body having
a front side defined by a forward direction of travel of the recreational vehicle,
a rear side defined by a rearward direction of travel of the recreational vehicle,
an inner side proximate a longitudinal centerline of the recreational vehicle,
an outer side distal a longitudinal centerline of the recreational vehicle,
an upper portion adapted to be moveably coupled to a portion of a steering system of the recreational vehicle,
a lower portion adapted to be moveably coupled to a ground engaging element of the recreational vehicle,
first and second protrusions projecting from the inner side of the body, the first protrusion being disposed generally above the second protrusion, the first and second protrusions being adapted to be moveably coupled to a portion of a suspension system of the recreational vehicle;
wherein the elongated body has an axis of rotation defined by a line which passes through the first and second protrusions, and
wherein the elongated body is formed as an aluminum extrusion, the aluminum extrusion having a direction of extrusion that is generally parallel to the forward direction of travel of the recreational vehicle.

16. The spindle of claim 15 wherein at least one of the first and second protrusions is adapted to be moveably coupled to an A-frame suspension element.

17. The spindle of claim 15 wherein at least one of the first and second protrusions is adapted to be moveably coupled to a trailing arm suspension element.

18. The spindle of claim 15 wherein at least one of the front and rear sides of the spindle is adapted to mountably receive a cover.

19. The spindle of claim 15 further comprising a third protrusion projecting from the inner side of the body, the third protrusion being adapted to be moveably coupled to a portion of a suspension system of the recreational vehicle.

20. A method of supporting a recreational vehicle comprising:
providing a body having
a front side defined by a forward direction of travel of the recreational vehicle,
a rear side defined by a rearward direction of travel of the recreational vehicle,
an inner side proximate a longitudinal centerline of the recreational vehicle,
an outer side distal a longitudinal centerline of the recreational vehicle,
an upper portion adapted to be moveably coupled to a portion of a steering system of the recreational vehicle,
a lower portion adapted to be moveably coupled to a ground engaging element of the recreational vehicle,
first and second protrusions projecting from the inner side of the body, the first protrusion being disposed generally above the second protrusion, the first and second protrusions being adapted to be moveably coupled to a portion of a suspension system of the recreational vehicle,
wherein the elongated body has an axis of rotation defined by a line which passes through the first and second protrusions;
attaching the body to the portion of a suspension system of the recreational vehicle; and
attaching the body to the ground-engaging element.

21. The method of claim 20 wherein the portion of a suspension system includes at least one A-frame suspension element.

22. The method of claim 20 wherein the portion of a suspension system includes at least one trailing arm suspension element.

23. The method of claim 20 wherein the ground-engaging element comprises a ski.

24. A method of supporting a snowmobile comprising:
providing a body having a front side defined by a forward direction of travel of the snowmobile,
a rear side defined by a rearward direction of travel of the snowmobile,
an inner side proximate a longitudinal centerline of the snowmobile,
an outer side distal a longitudinal centerline of the snowmobile,
an upper portion adapted to be moveably coupled to a portion of a steering system of the snowmobile,
a lower portion adapted to be moveably coupled to a ground engaging element of the snowmobile,
first and second means for movably coupling a portion of a suspension system to an inner side of the body, the first means being disposed generally above the second means,
wherein the elongated body has an axis of rotation defined by a line which passes through the first and second means, and
wherein the elongated body is formed as an aluminum extrusion, the aluminum extrusion having a direction of extrusion that is generally parallel to the forward direction of travel of the snowmobile;
attaching the body to the portion of a suspension system of the snowmobile; and
attaching the body to the ground engaging element of the snowmobile.

25. The method of claim 24 wherein the portion of a suspension system includes at least one A-frame suspension element.

26. The method of claim 24 wherein the portion of a suspension system includes at least one trailing arm suspension element.

27. The method of claim 24 wherein the ground-engaging element comprises a ski.

28. A method of manufacturing the support of claim 1, comprising the steps of:
providing a die assembly for use in an extrusion process;
providing a material to be extruded;
providing an extrusion press;
forcing the material through the die assembly with the extrusion press in a direction of extrusion, producing an extruded material; and
cutting the extruded material when the extruded material reaches a desired length, wherein a surface created by cutting the extruded material forms one of a front or rear side of the support, the surface being generally perpendicular to the direction of extrusion.

29. The method of claim 28 wherein the extrusion material is non-metallic.

30. The method of claim 28 wherein the extrusion material is a metal.

31. The method of claim 30 wherein the extrusion material is aluminum.
